(19) United States
(12) Patent Application Publication
(10) Pub. No.: US 2026/0103177 A1
(43) Pub. Date: Apr. 16, 2026

(54) HYDRAULIC OVERLAY SYSTEM FOR REDUCING BRAKE DRAG

(71) Applicant: Tesla, Inc., Austin, TX (US)

(72) Inventors: Benjamin Marc Russell Shiff, San Francisco, CA (US); Dylan Matthew Kunkel, Dublin, OH (US); Nils Lothar Koliha, San Leandro, CA (US)

(21) Appl. No.: 18/916,194

(22) Filed: Oct. 15, 2024

(51) Int. Cl. B60T 13/74

(52) U.S. Cl. CPC B60T 13/745; B60T 13/741; B60T 2201/12

(57) ABSTRACT

A system and method for reducing brake drag in vehicles equipped with electronic parking brakes (EPB) is disclosed. The system includes an EPB, a brake caliper with a piston having a seal groove containing a seal, a hydraulic brake system, and a controller. The controller detects EPB commands and causes the hydraulic brake system to increase pressure to a target level that displaces the seal within the seal groove. This displacement stores elastic potential energy in the seal, enabling improved piston retraction when the EPB is released. The method involves detecting EPB commands, increasing hydraulic pressure to the target level, and maintaining the pressure for a predetermined time during EPB operation. The system and method aim to reduce brake drag variability, improve vehicle efficiency, and enhance range by optimizing brake pad retraction after EPB engagement and release cycles.

### TECHNICAL FIELD

Examples of the present disclosure relate generally to automotive braking systems, specifically electronic parking brake systems and methods for reducing brake drag in vehicles.

### BACKGROUND

Electronic parking brake (EPB) systems have become increasingly common in modern vehicles, replacing traditional mechanical parking brakes with electronically controlled mechanisms. These systems offer advantages in terms of packaging, weight reduction, and integration with other vehicle systems. However, EPB systems can also introduce challenges related to brake performance and efficiency.

One significant issue that has been observed in vehicles equipped with EPB systems is brake drag variability. This phenomenon occurs when the brake pads fail to fully retract from the rotor surface after the brakes are released, resulting in ongoing friction and energy loss. Brake drag can have a measurable impact on vehicle efficiency and range, particularly in electric vehicles where energy conservation is critical.

The causes of brake drag in EPB systems are complex and can involve multiple factors, including the design of the brake caliper, the properties of seals and other components, and the interaction between hydraulic and electronic systems. Of particular concern is the behavior of the brake system during and after EPB engagement and release cycles.

Current approaches to mitigating brake drag in EPB systems have shown limited effectiveness. For example, while manually pumping the brake pedal can sometimes help restore proper clearance between the brake pads and rotor, this method is inconsistent and relies on driver intervention. Moreover, in electric vehicles with regenerative braking, drivers may rarely use the hydraulic brakes during normal operation, exacerbating the potential for undetected brake drag.

The automotive industry continues to seek improved solutions for reducing brake drag in EPB-equipped vehicles. Effective methods for ensuring consistent brake pad retraction and minimizing friction losses could lead to significant improvements in vehicle efficiency, range, and overall performance. Additionally, such advancements could contribute to more accurate and reliable results in standardized testing procedures, such as coastdown testing, which are crucial for determining vehicle efficiency ratings.

As vehicle manufacturers strive to meet increasingly stringent efficiency standards and consumer demands for extended driving range, addressing the challenges associated with EPB systems and brake drag remains an important area of technological development in the automotive sector.

### BRIEF DESCRIPTION OF THE SEVERAL VIEWS OF THE DRAWINGS

Throughout the drawings, reference numbers may be re-used to indicate correspondence between referenced elements. The drawings are provided to illustrate examples of the subject matter described herein and not to limit the scope thereof.

FIG. 1 is a diagram depicting a conventional hydraulic braking system with an Electronic Parking Brake (EPB) and without hydraulic overlay, according to certain examples.

FIG. 2 is a diagram depicting a hydraulic braking system with an EPB with hydraulic overlay, according to certain examples.

FIG. 3 is a flow diagram depicting a method of performing hydraulic overlay within a hydraulic braking system, according to certain examples.

### DETAILED DESCRIPTION

According to certain examples, the disclosed technology seeks to address several interconnected problems in modern automotive braking systems, particularly those equipped with electronic parking brakes (EPB).

One of the primary issues is brake drag variability, which has been observed for example during coastdown testing of vehicles with EPB systems.

This phenomenon occurs when the brake pads fail to fully retract from the rotor surface after the brakes are released, resulting in ongoing friction and energy loss. The impact of this brake drag can be significant, with some vehicles experiencing a measurable decrease in range due to this issue.

The causes of brake drag in EPB systems are complex and multifaceted. One key factor is the behavior of the brake system during and after EPB engagement and release cycles. When the EPB is applied and released without hydraulic pressure in the system, the seal within the brake caliper's piston may not deform sufficiently to store the elastic potential energy needed for proper piston retraction. This lack of stored energy can lead to inadequate running clearance between the brake pad and the rotor, resulting in persistent brake drag even after the EPB is disengaged.

Current approaches to mitigating brake drag in EPB systems have shown limited effectiveness. For instance, manually pumping the brake pedal can sometimes help restore proper clearance between the brake pads and rotor. However, this method is inconsistent and relies on driver intervention, which is not ideal for maintaining optimal brake performance.

Moreover, in electric vehicles with regenerative braking, drivers may rarely use the hydraulic brakes during normal operation, exacerbating the potential for undetected brake drag and its associated efficiency losses.

The problem is further complicated by the variability in brake drag across different vehicle models and brake caliper designs. Testing has shown that the impact of brake drag can vary significantly depending on the specific brake hardware used, with some configurations experiencing more severe effects than others.

A hydraulic overlay system for reducing brake drag in vehicles equipped with electronic parking brakes (EPB) is now described. According to certain examples, the system includes an EPB, a brake caliper with a piston containing a seal groove to accommodate a seal, a hydraulic brake system that in some examples includes a brake booster, and a controller. The controller is configured to detect EPB commands and control the hydraulic brake system accordingly. When an EPB command is detected, the controller causes the hydraulic brake system to increase pressure to a target level. This increased pressure causes the seal within the seal groove of the piston to deform, storing elastic potential energy.

In some examples, the system applies this hydraulic overlay during both EPB activation and deactivation. For example, when parking the vehicle, the system increases the hydraulic pressure as the EPB is engaged. Similarly, when preparing to drive, the system applies pressure as the EPB is released. This approach ensures consistent performance and maximizes the effectiveness of the drag reduction.

In some examples, the minimum vehicle hold pressure is increased to the target pressure (e.g., 10 bar) upon detecting a park or unpark command. The pressure ramp speed is also increased to achieve the target pressure within a short time frame, typically around 250 milliseconds.

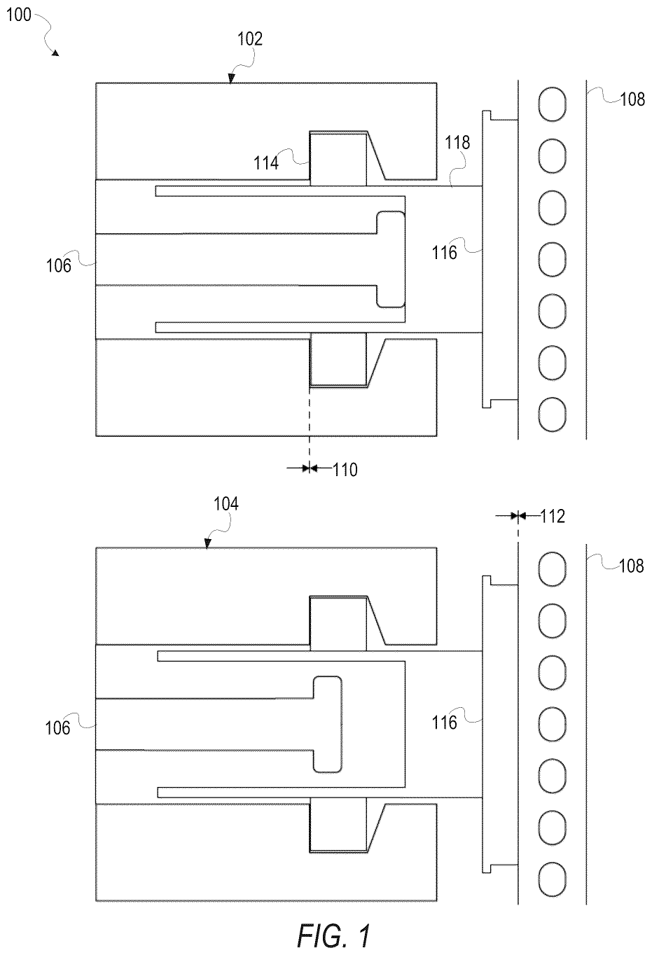

FIG. 1 illustrates a conventional hydraulic braking system 100 with an Electronic Parking Brake (EPB) that does not implement the hydraulic overlay solution described above. The figure comprises two cross-sections, 102 and 104, depicting the system in different states.

Cross-section 102 shows the hydraulic braking system 100 when the EPB is applied. In this state, the EPB spindle 106 extends, pushing the piston 118 outward. This action causes the piston 118 to press against the brake pad 116, which in turn applies pressure to the brake rotor 108. An aspect of this configuration is the seal 114, which remains undeformed when the EPB is applied. As a result, there is no stored rollback 110 in the system.

Cross-section 104 illustrates the system when the EPB is released. In this scenario, the EPB spindle 106 retracts. However, due to the lack of stored rollback 110 when the EPB was applied (as shown in cross-section 102), the brake pad 116 remains in contact with the brake rotor 108. Consequently, there is no running clearance 112 between the brake pad 116 and the brake rotor 108.

This configuration presents a significant technical problem in conventional hydraulic braking systems with EPBs. The lack of stored rollback 110 and subsequent absence of running clearance 112 when the EPB is released can lead to persistent brake drag. Brake drag occurs when the brake pads fail to fully retract from the rotor surface after the brakes are released, resulting in ongoing friction and energy loss.

The consequences of this brake drag can be substantial. It can cause increased energy consumption, reduced vehicle efficiency, and potentially decreased range, especially in electric vehicles where energy conservation is critical. Furthermore, this issue is exacerbated in vehicles that primarily rely on regenerative braking, as drivers may rarely use the hydraulic brakes during normal operation. This infrequent use can lead to undetected brake drag, further compromising vehicle efficiency.

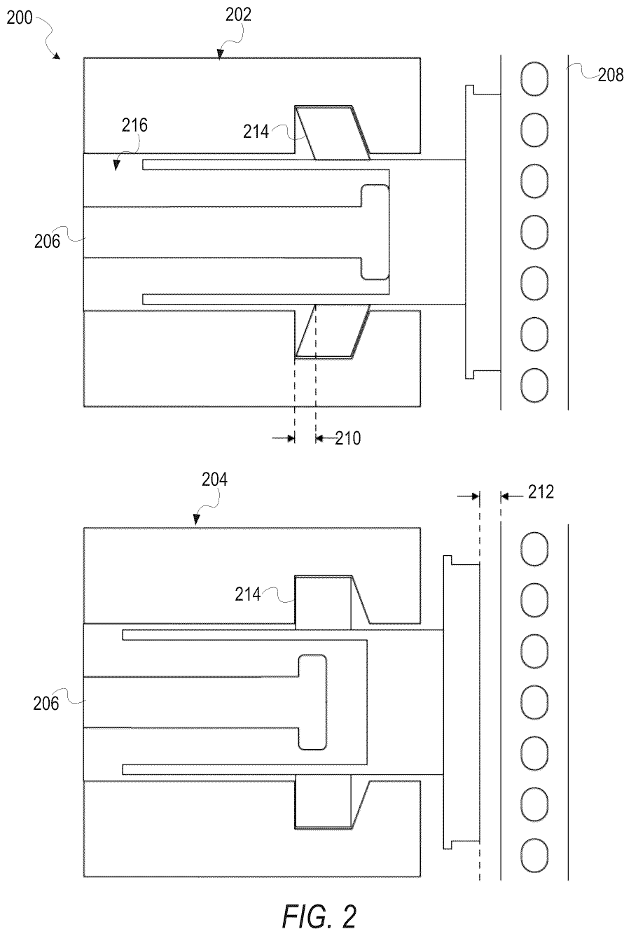

FIG. 2 illustrates a hydraulic braking system 200 with an EPB that implements an example hydraulic overlay configuration. The figure comprises two cross-sections, 202 and 204, depicting an example system in different states.

Cross-section 202 shows the hydraulic braking system 200 when the EPB is applied. In this state, the EPB spindle 206 extends, pushing the piston 214 outward. This action causes the piston 214 to press against the brake pad 218, which in turn applies pressure to the brake rotor 208. A notable aspect of this configuration is the seal 214, which is deformed by the pressure of the brake fluid 216. This deformation results in stored rollback 210, which can be helpful for proper brake pad retraction.

The hydraulic overlay solution involves increasing the hydraulic pressure in the system when an EPB command is detected. This is typically achieved by increasing the minimum vehicle hold pressure to a target level, usually at least 10 bar, upon detecting a park or unpark command. The pressure is rapidly increased, typically within 250 milliseconds, to ensure effective seal deformation.

According to certain examples, the system can build pressure within the hydraulic braking system by a brake booster, also known as a vacuum booster or power brake booster. The brake booster can build pressure in the hydraulic braking system by amplifying the force applied to the brake pedal. In the context of the hydraulic overlay system, the brake booster is used to rapidly increase and maintain hydraulic pressure when an EPB command is detected. This rapid pressure increase is achieved by controlling the brake booster through the vehicle's brake control systems.

Cross-section 204 illustrates the system when the EPB is released. In this scenario, the EPB spindle 206 retracts. Due to the stored rollback 210 caused by the pressure within the hydraulic braking system when the EPB was applied, the brake pad 218 is pulled away from the brake rotor 208 by the elastic potential in the seal 214, creating a running clearance 212.

The increased hydraulic pressure deforms the seal 214, storing elastic potential energy. When the EPB is released, this stored energy helps pull the piston 214 back, creating the necessary running clearance 212 between the brake pad 218 and the rotor 208.

In some examples, the system may use a controller to detect EPB commands and control the hydraulic brake system accordingly. When an EPB command is detected, the controller causes the hydraulic brake system to increase pressure to the target level. This pressure increase can be achieved through various means, such as controlling a brake booster associated with the hydraulic brake system.

According to certain examples, the hydraulic overlay is applied during both EPB activation and deactivation to ensure consistent performance. The increased pressure is maintained for a predetermined period of time, typically around 250 milliseconds, which is sufficient to deform the seal 214 and store the necessary elastic potential energy.

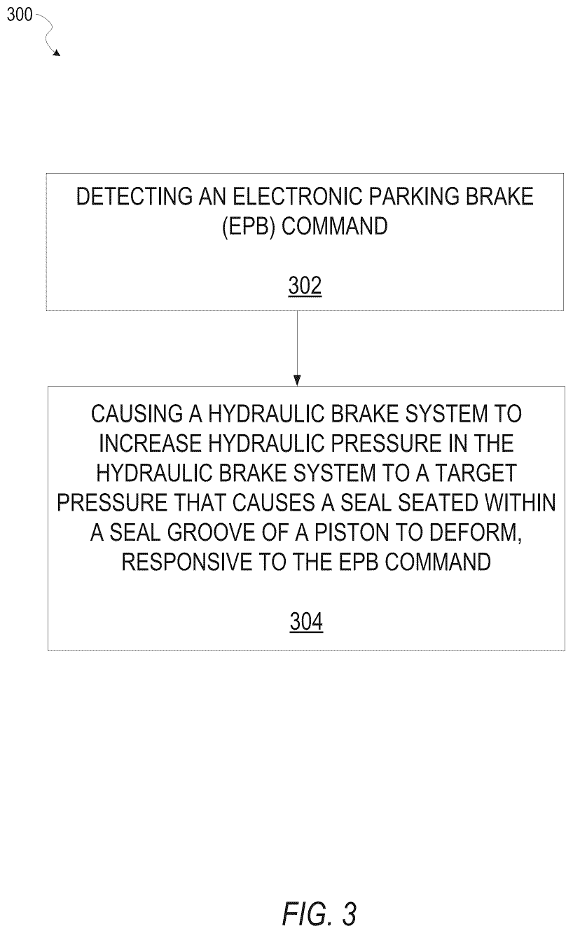

FIG. 3 illustrates a flow diagram 300 depicting a method of performing hydraulic overlay within a hydraulic braking system. The method 300 may comprise one or more operations 302 and 304, which may be performed by a hydraulic overlay system as described herein.

The method begins at operation 302, where the system detects an EPB command to either apply or release the EPB at a vehicle. This detection is performed by a controller configured to monitor EPB commands.

The EPB command can be triggered by various events, such as the driver engaging or disengaging the parking brake, or as part of an automatic parking sequence.

At operation 304, the system responds to the detected EPB command by causing the hydraulic brake system to increase hydraulic pressure to a target pressure. This increased pressure causes a seal seated within a seal groove of a piston to deform.

In some examples, the target pressure for the hydraulic overlay system may be set to a level that effectively deforms the seal while avoiding undesirable side effects. The chosen pressure level should be sufficient to cause the necessary seal deformation to store elastic potential energy, which is crucial for proper piston retraction and brake drag reduction. However, the pressure should not be so high as to introduce other issues that could negatively impact the driver experience or vehicle performance, such as excessive brake pedal movement or unwanted noise from the braking system.

The hydraulic pressure increase in the system may be configured to occur within a brief timeframe that allows for effective seal deformation while maintaining system responsiveness. The specific duration of this pressure ramp-up can be optimized based on the particular vehicle platform and brake system configuration. This rapid pressure increase is crucial for ensuring that the seal deformation occurs quickly enough to respond effectively to the EPB command, thereby facilitating proper piston retraction and minimizing brake drag. The timing of the pressure increase is balanced to achieve the desired seal deformation without introducing delays in EPB operation or other undesirable effects on the braking system's performance.

In some examples, the pressure increase can be accomplished through various means, such as controlling a brake booster or iBooster associated with the hydraulic brake system.

When the seal deforms, it stores elastic potential energy, which later aids in piston retraction when the EPB is released. This stored energy helps create a proper running clearance between the brake pad and the rotor, reducing brake drag. In some examples, the method includes maintaining the increased hydraulic pressure for a predetermined period of time after the initial pressure increase. This sustained pressure ensures that the seal remains deformed long enough to effectively store the elastic potential energy.

In some examples, the method is be applied during both EPB activation and deactivation cycles. When the EPB is being applied, the hydraulic overlay helps ensure consistent brake performance. When the EPB is being released, the hydraulic overlay aids in proper piston retraction, minimizing brake drag.

### GLOSSARY

In some examples, the following definitions may apply, in context:

Electronic Parking Brake (EPB): An electronically-controlled mechanism that engages and disengages the parking brake.

Brake Drag: Unwanted friction between brake components when brakes are not intentionally applied.

Running Clearance: The space between the brake pad and rotor when the brakes are not applied.

Brake Booster: A device that amplifies the force applied to the brake pedal to increase hydraulic pressure.

iBooster: An electronically controlled brake booster.

Coastdown Testing: A method of evaluating vehicle performance and efficiency, including the effects of brake drag.

### EXAMPLES

Some examples may include one or more of the following aspects.

Example 1 is a system to reduce brake drag, comprising: a hydraulic brake system; an electronic parking brake (EPB) operable to work in conjunction with the hydraulic brake system; a brake caliper that includes a piston having a seal groove to accommodate a seal within the seal groove; a controller configured to perform operations that include: detecting an EPB command; and causing the hydraulic brake system to boost hydraulic pressure in the hydraulic brake system to a target pressure that causes or assists the seal to deform responsive to the EPB command.

In Example 2, the subject matter of Example 1, wherein the operations further comprise: causing the hydraulic pressure to maintain the target pressure for a predetermined period of time responsive to the EPB command.

In Example 3, the subject matter of Examples 1-2, wherein the EPB command is a first EPB command to activate the EPB, and the operations further comprise: detecting a second EPB command to deactivate the EPB; and causing the hydraulic brake system to increase the hydraulic pressure to the target pressure responsive to the second EPB command to deactivate the EPB.

In Example 4, the subject matter of Examples 1-3, wherein the causing the hydraulic brake system to increase the hydraulic pressure includes: causing a brake booster associated with the hydraulic brake system to increase the hydraulic pressure to the target pressure.

In Example 5, the subject matter of Examples 1-4, wherein the causing the hydraulic brake system to increase the hydraulic pressure includes: causing the hydraulic brake system to increase the hydraulic pressure within a threshold period of time responsive to the EPB command.

In Example 6, the subject matter of Examples 1-5, wherein the threshold period of time is 250 milliseconds.

In Example 7, the subject matter of Examples 1-6, wherein the deformed seal comprises stored elastic potential energy to enable piston retraction.

In Example 8, the subject matter of Examples 1-7, wherein the target pressure is at least 10 bar.

In Example 9, the subject matter of Examples 1-8, wherein the deformed seal comprises stored elastic potential energy, and wherein the operations further comprise: causing the piston to retract based on the stored elastic potential energy of the deformed seal.

In Example 10, the subject matter of Examples 1-9, wherein the system includes a system to reduce brake drag of a vehicle.

In Example 11, the subject matter of Examples 1-10, wherein the piston is in contact with a brake pad.

Example 12 is a method comprising: detecting, by a controller of a vehicle, an electronic parking brake (EPB) command; and causing a hydraulic brake system to increase hydraulic pressure in the hydraulic brake system to a target pressure that causes a seal within a seal groove of a piston of the hydraulic brake system to deform, responsive to the EPB command.

In Example 13, the subject matter of Example 12, further comprising: causing the hydraulic pressure to maintain the target pressure for a predetermined period of time responsive to the EPB command.

In Example 14, the subject matter of Examples 12-13, wherein the EPB command is a first EPB command to activate the EPB, and the method further comprises: detecting a second EPB command to deactivate the EPB; and causing the hydraulic brake system to increase the hydraulic pressure to the target pressure responsive to the second EPB command to deactivate the EPB.

In Example 15, the subject matter of Examples 12-14, wherein the causing the hydraulic brake system to increase the hydraulic pressure includes: causing a brake booster associated with the hydraulic brake system to increase the hydraulic pressure to the target pressure.

In Example 16, the subject matter of Examples 12-15, wherein the causing the hydraulic brake system to increase the hydraulic pressure includes: causing the hydraulic brake system to increase the hydraulic pressure within a threshold period of time responsive to the EPB command.

In Example 17, the subject matter of Examples 12-16, wherein the threshold period of time is 250 milliseconds.

In Example 18, the subject matter of Examples 12-17, wherein the deformed seal comprises stored elastic potential energy to enable piston retraction.

In Example 19, the subject matter of Examples 12-18, wherein the target pressure is at least 10 bar.

In Example 20, the subject matter of Examples 12-19, wherein the deformed seal comprises stored elastic potential energy, and wherein the operations further comprise: causing the piston to retract based on the stored elastic potential energy of the deformed seal.

While the above is a detailed description of some examples of the inventive subject matter, various alternatives, modifications, and equivalents may be used. Therefore, the above description should not be taken as limiting the scope of the inventive subject matter which is defined by the appended claims.

What is claimed is:

1. A system to reduce brake drag, comprising:
a hydraulic brake system;
an electronic parking brake (EPB) operable to work in conjunction with the hydraulic brake system;
a brake caliper that includes a piston having a seal groove to accommodate a seal within the seal groove;
a controller configured to perform operations that include:
detecting an EPB command; and
causing the hydraulic brake system to boost hydraulic pressure in the hydraulic brake system to a target pressure that causes or assists the seal to deform responsive to the EPB command.

2. The system of claim 1, wherein the operations further comprise: causing the hydraulic pressure to maintain the target pressure for a predetermined period of time responsive to the EPB command.

3. The system of claim 2, wherein the EPB command is a first EPB command to activate the EPB, and the operations further comprise:
detecting a second EPB command to deactivate the EPB; and
causing the hydraulic brake system to increase the hydraulic pressure to the target pressure responsive to the second EPB command to deactivate the EPD.

4. The system of claim 1, wherein the causing the hydraulic brake system to increase the hydraulic pressure includes:
causing a brake booster associated with the hydraulic brake system to increase the hydraulic pressure to the target pressure.

5. The system of claim 1, wherein the causing the hydraulic brake system to increase the hydraulic pressure includes:
causing the hydraulic brake system to increase the hydraulic pressure within a threshold period of time responsive to the EPB command.

6. The system of claim 5, wherein the threshold period of time is 250 milliseconds.

7. The system of claim 1, wherein the deformed seal comprises stored elastic potential energy to enable piston retraction.

8. The system of claim 1, wherein the target pressure is at least 10 bar.

9. The system of claim 1, wherein the deformed seal comprises stored elastic potential energy, and wherein the operations further comprise:
causing the piston to retract based on the stored elastic potential energy of the deformed seal.

10. The system of claim 1, wherein the system includes a system to reduce brake drag of a vehicle.

11. The system of claim 1, wherein the piston is in contact with a brake pad.

12. A method comprising:
detecting, by a controller of a vehicle, an electronic parking brake (EPB) command; and
causing a hydraulic brake system to increase hydraulic pressure in the hydraulic brake system to a target pressure that causes a seal within a seal groove of a piston of the hydraulic brake system to deform, responsive to the EPB command.

13. The method of claim 12, further comprising:
causing the hydraulic pressure to maintain the target pressure for a predetermined period of time responsive to the EPB command.

14. The system of claim 13, wherein the EPB command is a first EPB command to activate the EPB, and method further comprises:
detecting a second EPB command to deactivate the EPB; and
causing the hydraulic brake system to increase the hydraulic pressure to the target pressure responsive to the second EPB command to deactivate the EPD.

15. The system of claim 12, wherein the causing the hydraulic brake system to increase the hydraulic pressure includes:
causing a brake booster associated with the hydraulic brake system to increase the hydraulic pressure to the target pressure.

16. The system of claim 12, wherein the causing the hydraulic brake system to increase the hydraulic pressure includes:
causing the hydraulic brake system to increase the hydraulic pressure within a threshold period of time responsive to the EPB command.

17. The system of claim 16, wherein the threshold period of time is 250 milliseconds.

18. The system of claim 12, wherein the deformed seal comprises stored elastic potential energy to enable piston retraction.

19. The system of claim 12, wherein the target pressure is at least 10 bar.

20. The system of claim 12, wherein the deformed seal comprises stored elastic potential energy, and wherein the operations further comprise:
causing the piston to retract based on the stored elastic potential energy of the deformed seal.
